(19) United States
(12) Patent Application Publication
(10) Pub. No.: US 2013/0101295 A1
(43) Pub. Date: Apr. 25, 2013

(54) COMPACT TUNABLE OPTICAL OFDM SOURCE

(71) Applicant: Nicolas Dupuis, New York, NY (US)

(72) Inventor: Nicolas Dupuis, New York, NY (US)

(21) Appl. No.: 13/277,499

(22) Filed: Oct. 20, 2011

(51) Int. Cl. H04J 14/00; H04B 10/04

(52) U.S. Cl. 398/79

(57) ABSTRACT

An optical transmitter includes first and second optical single sideband modulators. The first optical single sideband modulator is configured to receive an input optical signal and produce a first frequency-shifted optical signal. The first frequency-shifted optical signal has a first frequency shift with respect to the input optical signal. The second optical single sideband modulator is configured to receive the first frequency-shifted optical signal and produce a second frequency-shifted optical signal. The second frequency-shifted optical signal has a second different frequency shift with respect to the input optical signal.

### TECHNICAL FIELD

This application is directed, in general, to optical devices and systems, and method of manufacturing the same.

### BACKGROUND

Some optical transmission systems, such as those employing optical orthogonal frequency-division multiplexing (OFDM), typically use a comb generator to produce a number of frequency channels in a transmission spectrum. Such a system may employ various optical components, such as circulators and demultiplexers, in the process of modulating individual optical channels with transmission data. These components may be relatively large and complex, leading to system designs that are costly and bulky.

### SUMMARY

An optical transmitter includes first and second optical single sideband modulators. The first optical single sideband modulator (SSBM) is configured to receive an input optical signal and produce a first frequency-shifted optical signal. The first frequency-shifted optical signal has a first frequency shift with respect to the input optical signal. The second optical SSBM is configured to receive the first frequency-shifted optical signal and produce a second frequency-shifted optical signal. The second frequency-shifted optical signal has a second different frequency shift with respect to the input optical signal.

Another aspect provides an optical orthogonal frequency-division multiplexer transmitter. The transmitter includes an input optical splitter and first and second SSBMs. The first SSBM has an input connected to a first output of the input splitter. The second SSBM has an input connected to a second output of the input splitter. An output optical combiner is configured to receive at a first input a first signal frequency-shifted by the first SSBM, and to receive at a second input a second signal frequency-shifted by the second SSBM.

Another aspect is a method. The method includes configuring a first optical SSBM to receive an input optical signal. The method further includes configuring the first SSBM to produce a first frequency-shifted optical signal having a first frequency shift with respect to the input optical signal. A second optical SSBM is configured to receive the input optical signal and produce a second frequency-shifted optical signal having a second different frequency shift with respect to the input optical signal. A combiner is configured to combine the first and second frequency-shifted optical signals, thereby forming a frequency comb.

### BRIEF DESCRIPTION

Reference is now made to the following descriptions taken in conjunction with the accompanying drawings, in which:

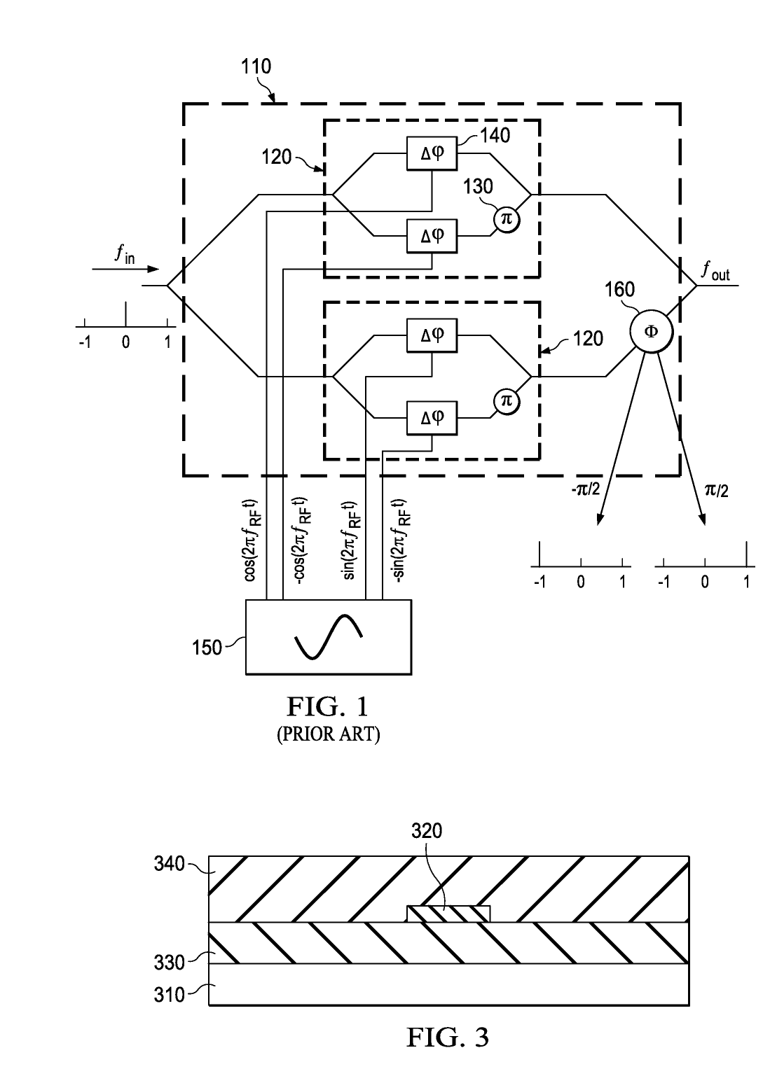

FIG. 1 illustrates a prior art SSBM that may be used in an optical transmission system of the disclosure;

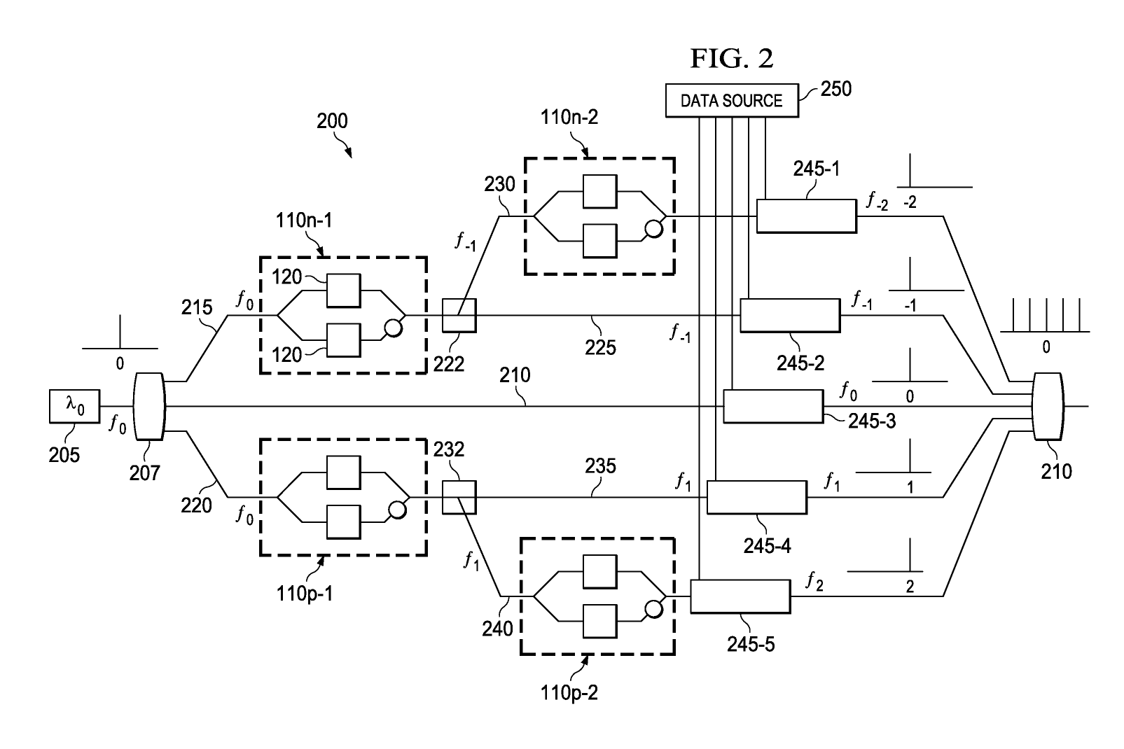

FIG. 2 illustrates an optical transmission system according to one embodiment, that may use the SSBM of FIG. 1;

FIG. 3 is a sectional view of a portion of the optical transmission system of FIG. 2, illustrating various structural aspects of the transmission system in an illustrative embodiment; and

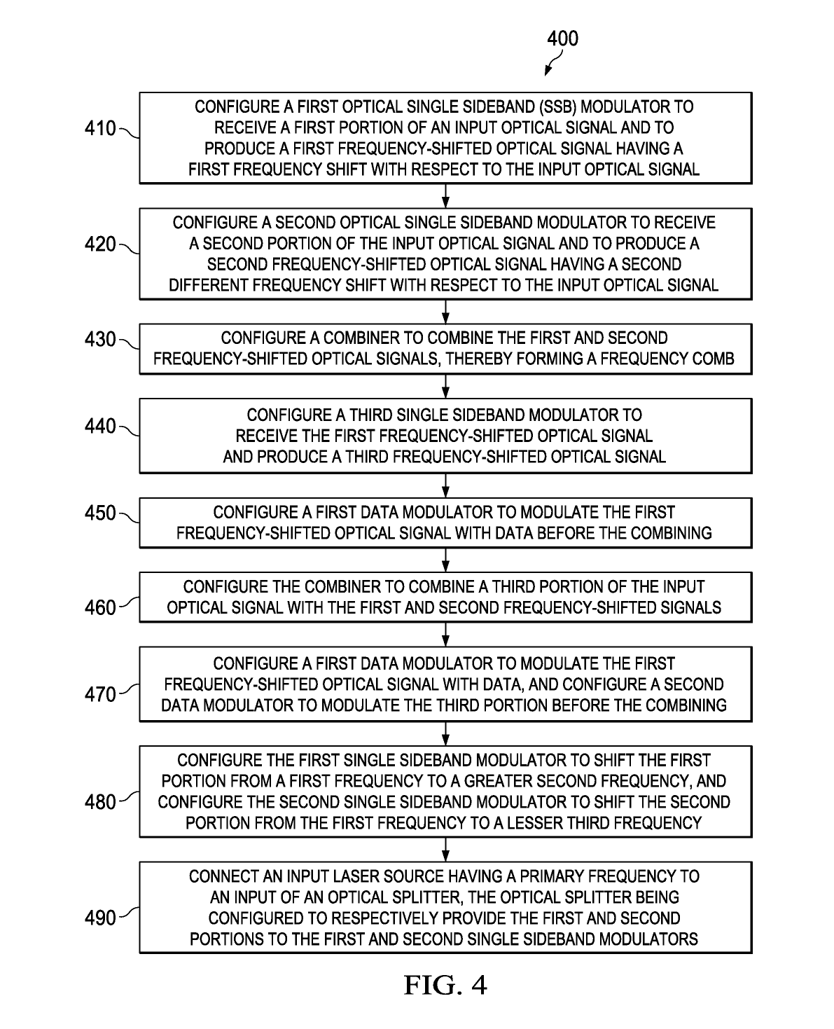

FIG. 4 presents a method of, e.g. forming an optical transmission system according to one embodiment, e.g. the system of FIG. 2.

### DETAILED DESCRIPTION

Because conventional optical transmission systems, e.g. OFDM systems, typically use relatively complex designs to demultiplex and modulate each optical channel, such systems are often complex and costly. Some optical OFDM transmitters employ components such as circulators and demultiplexers to separate optical channel carriers from a frequency comb prior to modulating the carriers. Such components are typically not compatible with high level integration techniques, making cost and size reduction difficult to achieve.

Embodiments herein address the need for a higher level of integration in such systems by providing an innovative design that eliminates the need for the comb generator by forming channel carriers with a number of cascaded single sideband modulators (SSBMs). The SSBMs are used to produce from a primary optical carrier signal a number of secondary carrier signals, wherein each of the secondary carrier signals is substantially monochromatic and has a different frequency than others of the carrier signals. Each carrier signal may be independently modulated and then combined by a planar combiner to produce a frequency comb. The SSBMs, splitter and combiner may be integrated on a single substrate to form a very compact optical OFDM system since no optical demultiplexer is needed. The high degree of integration may also lower system costs as compared to typical conventional optical OFDMS transmission systems.

FIG. 1 illustrates a prior art single sideband modulator (SSBM) 110. The SSBM 110 receives an optical input signal having a frequency fᵢₙ and a wavelength kᵢₙ and produces a frequency-shifted output signal fₒᵤₜ. For brevity, fᵢₙ may be represented symbolically as “0” with an associated peak in the frequency domain. The SSBM 110 includes two balanced Mach-Zehnder (MZ) modulators 120. One arm of each modulator 120 includes a fixed phase shift 130 of about π radians, e.g. a λᵢₙ/2 extra path length relative to the other arm. Each arm includes a phase modulator (PM) 140 that produces a variable phase shift ±Δφ. The PMs 140 of each modulator 120 are driven in a push-pull configuration by an RF source 150 that provides a drive signal with frequency f_{RF}. The two MZ modulators 120 are fed optically and electrically in quadrature in order to suppress one of two side bands of fᵢₙ at the output.

Depending on the value of a phase shift Δφ produced by a phase shifter 160, the energy at fᵢₙ may be transferred either to an upper side band (USB) or to a lower side band (LSB) of fᵢₙ. For example, when Δφ is about −π/2, the energy at fᵢₙ is shifted left to the LSB, e.g. to a lower frequency fᵢₙ−f_{RF}. Conversely, when Δφ is about +π/2, the energy at fᵢₙ is shifted right to the USB, e.g. to a higher frequency fᵢₙ+f_{RF}. The USB and the LSB may be represented symbolically as “1” and “−1”, respectively, and illustrated as associated peaks in the frequency domain.

The efficiency and the harmonic distortion of the frequency conversion depend on the amplitude |Δφ| of the phase shift produced by the modulators 140 and also on their linearity. In various embodiments |Δφ| may be about it radians.

The frequency shift of the LSB and the USB may be varied by varying f_{RF}, synonymously referred to herein as Δf.

Thus, Δf is tunable by the selection of the RF frequency of the RF source 150. The magnitude of Δf is in principle limited only by the bandwidth of the modulators 140, e.g. about 20 GHz in some embodiments. In various embodiments the energy of the input signal fᵢₙ is substantially transferred to the USB or the LSB at fₒᵤₜ, e.g. by at least about 20 dB compared to the peak at fᵢₙ+Δf.

In the description below, an instance of the SSBM 110 that is configured to produce a positive frequency shift is referred to as an SSBM 110p, while an instance of the SSBM that is configured to produce a negative frequency shift is referred to as an SSBM 110n.

FIG. 2 illustrates an optical transmitter, e.g. an optical OFDM transmitter 200 according to one embodiment that includes cascaded instances of the SSBM 110. The transmitter 200 is configured to receive from an input laser source 205 a primary optical carrier signal with a primary frequency f₀ at an input splitter 207. The transmitter 200 is further configured to produce at an output combiner 210 an optical comb, e.g. optical power concentrated at a plurality of frequency peaks spaced by about Δf.

The laser source 205 may be a component separate from a substrate on which the transmitter 200 is otherwise formed, or may be integrated with the other components over the same substrate. Methods of coupling the laser source 205, e.g. by butt-joint or selective are growth techniques, are well known to those skilled in the optical arts. In some embodiments the laser source 205 is configured to couple to a zeroth mode of an unreferenced input waveguide connected to the splitter 207. In various embodiments the frequency f₀ is within a range from about 1500 nm to about 1600 nm.

The input splitter 207 is illustrated having three outputs, but embodiments are not limited to any particular number of outputs. A waveguide 215 connects a first output of the splitter 207 to an instance of the SSBM 110 designated 110n-1. A waveguide 220 connects a second output of the splitter 207 to an instance of the SSBM 110 designated 110p-1. A third output of the splitter 207 is not frequency-shifted.

The SSBM 110n-1 produces an output signal with a frequency f₋₁=f₀−Δf. The output signal is split by a coupler 222 between a waveguide 225 and a waveguide 230, with a portion of the output signal being directed to an instance of the SSBM 110 designated 110n-2. The SSBM 110n-2 produces an output signal with a frequency f₋₂=f₀−2Δf.

Similarly, an SSBM 110p-1 receives a portion of the primary carrier via the waveguide 220 and produces an output signal with a frequency f₁=f₀+Δf. The output signal is split by a coupler 232 between waveguides 235 and 240, with a portion of the output signal being directed to an instance of the SSBM 110 designated 110p-2. The SSBM 110p-2 produces an output signal with a frequency f₂=f₀+2Δf.

The signals with frequencies f₋₂, f₋₁, f₀, f₁, f₂ are received by corresponding data modulators 245-1, 245-2, 245-3, 245-4 and 245-5. These may be referred to in the singular as a data modulator 245 when distinction is unnecessary, or collectively as data modulators 245. The data modulators 245 may be nominally identical, and may include, e.g. a Mach-Zehnder Interferometer (MZI). The modulation may be by any appropriate method, e.g. on-off keying (OOK), phase-shift keying (PSK) or more advanced format such as quadrature amplitude modulation (QAM) and quadrature phase-shift keying (QPSK).

The data modulators 245 receive data from a data source 250, which is configured to provide the data in any appropriate digital format. In various embodiments the symbol rate of the modulation is about equal to the &f spacing of the frequency comb, e.g. f_{RF}. The data modulators 245 are distinguished from the SSBMs 110 in that the SSBMs 110 in the illustrated embodiment shift a frequency of a received signal but do not impart data on the frequency shifted signal. In contrast in the illustrated embodiment the data modulators 245 do not modulate the frequency of the received signal, but impart data by, e.g. modulating the phase and/or amplitude of the received signal.

The modulated outputs of the data modulators 245 are received by the output combiner 210, in which they are combined into a single optical output signal. The output signal includes contributions from each of the SSBMs 110, as well as the contribution at the carrier frequency f₀. Thus the resulting comb has n+1 frequency peaks, where n is the number of SSBMs 110 employed in the design. In the illustrated embodiment, the frequency components of the comb are symmetric about, e.g. about centered on, the primary frequency f₀. However, embodiments of the disclosure are not limited to such configurations.

In some embodiments the frequency comb may not be flat, e.g. the output power associated with each frequency component may not be equal. This feature, which may be undesirable, may result from different optical losses in the different branches of the transmitter 200. If desired comb flatness may be improved by configuring the splitter 207 and/or the couplers 222 and 232 with unequal power distribution to compensate for losses and power division within the branches.

It is apparent from the foregoing description that the transmitter 200 operates to provide a frequency comb of modulated optical channels without the use of an optical demultiplexer. This aspect is in contrast to conventional optical OFDM transmitters, and enables a spatially compact transmitter design. In further contrast with typical conventional design, the components of the modulator 200 may be implemented as an integrated system on an optical substrate using conventional or novel fabrication methods. However, embodiments are not limited to integrated designs on a common substrate. In addition to the possible compactness of various embodiments, the transmitter 200 may be fabricated with a substantially lower cost than typical conventional systems of similar functionality. Such embodiments are also expected to have significantly improved reliability due to, e.g. a lower number of optical interconnections.

FIG. 3 illustrates aspects of the physical construction of the transmitter 200 in various embodiments. The transmitter 200 as further described by FIG. 3 may be formed by techniques known to those skilled in the pertinent art.

The transmitter 200 includes a substrate 310 in sectional view that may be any substrate type compatible with formation of integrated optical devices. In a nonlimiting example, the substrate 310 is a semiconductor substrate that comprises a material such as Si, GaAs or InP.

A waveguide 320 formed over the substrate 310 is representative of any of the waveguides shown in FIG. 2, e.g. the waveguides 215, 220, 225, 230, 235 and 240, as well as components such as the splitter 207, the couplers 222 and 232, and the combiner 210. The waveguide 320 may be a ridge waveguide or a planar waveguide, and may be formed of any conventional or novel waveguide material using any conventional or novel process. In various embodiments the waveguide 320 comprises Si, GaAs, or InGaAsP. In an illustrative and nonlimiting embodiment the waveguide 320 has a width of about 1.8 μm and a height of about 2.5 μm when formed of InP.

A cladding layer 330 located between the waveguide 320 and the substrate 310 optically isolates signals propagating in the waveguide 320 from the substrate 310 and supports propagation of the signals within the waveguide 320. In one example, when the substrate 310 comprises silicon the cladding layer 330 may be, e.g. a thermal or plasma oxide of silicon. In another example, when the substrate 310 comprises InP the cladding layer 330 may include InP.

A dielectric layer 340 may overlie the waveguide 320. The dielectric layer 340 may be, e.g. a spin-on or CVD organic material such as spin-on glass, plasma silicon oxide, benzocyclobutene (BCB), parylene, poly(tetrafluoroethylene) (PTFE), or similar materials. The cladding layer 330 and the dielectric layer 340 provide a cladding with a relatively low refractive index as compared to the waveguide 320 to support guided propagation of optical signals therein. In some cases it is preferred for the dielectric layer 340 to have a dielectric permittivity of about 2.7 or less to limit optical losses in the system 200.

Turning to FIG. 4 a method 400, e.g. of forming an optical device, is presented in an illustrative embodiment. The steps of the method 400 may be carried out in an order other than the illustrated order. Moreover, the method 400 may include steps other than those shown, or may not include some steps that are shown. The method 400 is described without limitation by reference to features of the various embodiments described above, e.g. in FIGS. 2-3.

In a step 410 a first optical single sideband modulator, e.g. the SSBM 110n-1, is configured to receive a first portion of an input optical signal and produce a first frequency-shifted optical signal. The first frequency-shifted optical signal has a first frequency shift with respect to the input optical signal. In a step 420 a second optical single sideband modulator, e.g. the SSBM 110p-1, is configured to receive a second portion of the input optical signal and to produce a second frequency-shifted optical signal. The second frequency-shifted optical signal has a second different frequency shift with respect to the input optical signal. In a step 430 a combiner, e.g. the combiner 210, is configured to combine the first and second frequency-shifted optical signals, thereby forming a frequency comb.

In a step 440 a third single sideband modulator, e.g. the SSBM 110n-2, is configured to receive the first frequency-shifted optical signal and produce a third frequency-shifted optical signal.

In a step 450 a first data modulator, e.g. the data modulator 245-2, is configured to modulate the first frequency-shifted optical signal with data before the combiner combines the first and second frequency-shifted optical signals.

In a step 460 the combiner is configured to combine a third portion of the input optical signal with the first and second frequency-shifted signals. In a step 470 a first data modulator is configured to modulate the first frequency-shifted optical signal with data, and configure a second data modulator to modulate the third portion before the combining.

In a step 480 the first single sideband modulator is configured to shift the first portion from a first frequency to a greater second frequency. The second single sideband modulator is configured to shift the second portion from the first frequency to a lesser third frequency.

In a step 490 an input laser source having a primary frequency is connected to an input of an optical splitter. The optical splitter is configured to respectively provide the first and second portions to the first and second single sideband modulators.

Those skilled in the art to which this application relates will appreciate that other and further additions, deletions, substitutions and modifications may be made to the described embodiments.

What is claimed is:

1. An optical transmitter, comprising:
a first optical single sideband modulator configured to receive an input optical signal and produce a first frequency-shifted optical signal having a first frequency shift with respect to said input optical signal;
a second optical single sideband modulator configured to receive said first frequency-shifted optical signal and produce a second frequency-shifted optical signal having a second different frequency shift with respect to said input optical signal.

2. The transmitter recited in claim 1, wherein said first and second optical single sideband modulators are located over an InP substrate.

3. The transmitter recited in claim 1, further comprising a solid dielectric medium located over said first and second optical single sideband modulators.

4. The transmitter recited in claim 3, wherein said solid dielectric medium comprises BCB.

5. The transmitter recited in claim 1, further comprising an input optical splitter configured to provide said input optical signal to said first optical single sideband modulator.

6. The transmitter recited in claim 1, further comprising third and fourth optical single sideband modulators, wherein said optical single sideband modulators are configured to produce a frequency comb.

7. The transmitter recited in claim 1, further comprising first and second data modulators respectively configured to modulate said first and second frequency shifted output signals with data.

8. An optical orthogonal frequency-division multiplexer system, comprising:
an input optical splitter;
a first single sideband modulator having an input connected to a first output of said input splitter;
a second single sideband modulator having an input connected to a second output of said input splitter; and
an output optical combiner configured to receive at a first input a first signal frequency-shifted by said first single sideband modulator, and to receive at a second input a second signal frequency-shifted by said second single sideband modulator.

9. The system recited in claim 8, further comprising a third single sideband modulator connected between said first single sideband modulator and a third input of said output combiner, and a fourth single sideband modulator connected between said second single sideband modulator and a fourth input of said output combiner.

10. The system recited in claim 8, further comprising a first data modulator located between said first single sideband modulator output and said first input of said combiner, and a second data modulator located between said second single sideband modulator output and said second input of said combiner.

11. The system recited in claim 10, further comprising a third data modulator connected between a third output of said input splitter output and a third input of said output combiner.

12. The system recited in claim 8, wherein said output optical combiner is configured to receive from a third output of said input splitter an optical signal at a same frequency as an input signal received at an input of said input splitter.

13. The system recited in claim 8, wherein said first single sideband modulator is configured to shift an input optical signal from an input frequency to a greater output frequency, and said second single sideband modulator is configured to shift said input optical signal from said input frequency to a lesser output frequency.

14. A method, comprising:
configuring a first optical single sideband modulator to receive a first portion of an input optical signal and to produce a first frequency-shifted optical signal having a first frequency shift with respect to said input optical signal;
configuring a second optical single sideband modulator to receive a second portion of said input optical signal and to produce a second frequency-shifted optical signal having a second different frequency shift with respect to said input optical signal; and
configuring a combiner to combine said first and second frequency-shifted optical signals, thereby forming a frequency comb.

15. The method recited in claim 14, further comprising configuring a first data modulator to modulate said first frequency-shifted optical signal with data before said combining.

16. The method recited in claim 15, further comprising configuring said combiner to combine a third portion of said input optical signal with said first and second frequency-shifted signals.

17. The method recited in claim 16, further comprising configuring a first data modulator to modulate said first frequency-shifted optical signal with data, and configuring a second data modulator to modulate said third portion before said combining.

18. The method recited in claim 14, further comprising configuring said first single sideband modulator to shift said first portion from a first frequency to a greater second frequency, and configuring said second single sideband modulator to shift said second portion from said first frequency to a lesser third frequency.

19. The method recited in claim 14, further comprising configuring an input laser source to provide a primary frequency to an input of an optical splitter, the optical splitter being configured to respectively provide said first and second portions to said first and second single sideband modulators.

20. The method recited in claim 19, wherein an input laser source is integrated on a same substrate as said first and second single sideband modulators.
